(19) United States
(12) Patent Application Publication
(10) Pub. No.: US 2006/0165389 A1
(43) Pub. Date: Jul. 27, 2006

(54) DVD player

(75) Inventor: Ki Bok Yoo, Gyeongsangbuk-do (KR)

Correspondence Address: OSHA LIANG L.L.P., 1221 MCKINNEY STREET, SUITE 2800, HOUSTON, TX, 77010, US

(73) Assignee: Dongyang Electronics Co., Ltd., Gyeongsangbuk-do (KR)

(21) Appl. No.: 11/042,974

(22) Filed: Jan. 25, 2005

(51) Int. Cl. H04N 5/85

(52) U.S. Cl. 386/126

(57) ABSTRACT

A DVD player with a monitor is disclosed, for being automatically or manually opened and closed, which includes a base; a monitor being rotatably connected with the base; and a rotating device being connected with a motor of the base for turning the monitor, and having slip members of forming slip surfaces for turning the monitor by a predetermined external force.

### BACKGROUND OF THE INVENTION

1. Field of the Invention

The present invention relates to a DVD player, and more particularly, to a rotating device for rotating a monitor provided in a DVD player with a monitor.

2. Discussion of the Related Art

In general, a DVD player with a monitor reproduces images recorded in a DVD, and displays the reproduced images on the monitor.

The DVD player with a monitor is provided with a base, and the monitor connected with the base for reproducing the images thereon. The base is provided with a DVD inserting part and an image reproducing part, wherein the image reproducing part includes electrical components for reproducing the images recorded in the DVD.

Recently, the monitor is rotatably connected with the base. That is, if a user wants to watch a movie, the monitor is rotatably provided at a predetermined angle to the base. For this, there is requirement for providing a rotating device for rotating the monitor in the DVD player with a monitor.

In general, the rotating device is provided with a motor and a power transmission device. At this time, the motor generates a rotary power, and the power transmission device is connected with the motor to transmit the rotary power of the motor to the monitor.

However, the related art DVD player with the monitor has the following disadvantages.

In the related art DVD player with the monitor, the monitor is turned in a method of using the motor. In this case, if the motor has any trouble, it is impossible to turn the monitor. That is, the DVD player with a monitor cannot be used due to a small problem of the motor.

Also, if a force is excessively applied to the monitor by a user's carelessness, the rotating device may be damaged, or a connection part between the monitor and the base may be damaged.

### SUMMARY OF THE INVENTION

Accordingly, the present invention is directed to a DVD player with a monitor that substantially obviates one or more problems due to limitations and disadvantages of the related art.

An object of the present invention is to provide a DVD player with a monitor, which can be automatically or manually opened and closed.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a DVD player with a monitor includes a base; a monitor being rotatably connected with the base; and a rotating device being connected with a motor of the base for turning the monitor, and having slip members of forming slip surfaces, for turning the monitor manually by a predetermined external force.

At this time, the rotating device includes a shaft being inserted to a hole of a first rotating connection part provided in the monitor; and the slip members being closely adhered to one side and the other side of the first rotating connection part, for transmitting a rotary power of the shaft to the first rotating connection part, and for generating the slip surface being adhered to the first rotating connection part when the predetermined external force is applied to the monitor.

Also, the slip members include a first slip washer being adhered to one side of the first rotating connection part; and a second slip washer being adhered to the other side of the first rotating connection part.

Also, the first rotating connection part includes a first friction washer provided at one side of the first rotating connection part, and being adhered to the first slip washer; and a second friction washer provided at the other side of the first rotating connection part, and being adhered to the second slip washer.

Furthermore, the shaft has one side connected with a power transmission device for transmitting a rotary power of the motor, and the other side connected with a nut through the hole.

Also, the rotating device includes a first fixation washer provided between the second slip washer and the nut; and a second fixation washer provided between the first fixation washer and the nut.

Herein, the other side of the shaft is formed as a tapered surface.

Also, the second fixation washer has a hole corresponding to the tapered surface of the shaft.

Then, the power transmission device includes a gear train including a driving gear being rotated by the motor, and a following gear being connected with the shaft; and a braking device for applying a brake power to the gear train.

In addition, the gear train further includes an idle gear provided between the driving gear and the following gear.

Also, the braking device includes a spring washer provided at one side of the idle gear and being adhered to an inner wall of the base for obtaining a predetermined frictional force.

The base includes a friction washer being adhered to the brake washer for obtaining a predetermined frictional force.

Also, the friction washer includes a contact portion being in contact with the brake washer; and a fixing portion formed as one body with the contact portion, for being inserted to a recess formed in the inner wall of the base.

In addition, lubricating grease is provided to surfaces between the respective slip members and the first rotating connection part.

Also, the monitor includes the first rotating connection part provided at one corner of the monitor, for being connected with the rotating device; and a second rotating connection part provided at the other corner of the monitor, for being rotatably inserted to the base.

The second rotating connection part includes a cylindrical second shaft cover being rotatably inserted to a support hole formed in thee base, and having a hole at a shaft direction; and a second connection part formed as one body with the second shaft cover, and being connected with the other corner of the monitor.

At this time, the second connection part is connected with the monitor by screw.

The base includes a monitor receiving part for receiving the monitor in one surface thereof, and a recess formed along one edge of the monitor receiving part to help the edge of the monitor for being turned without any interference.

Also, the base becomes thinner as going from one side of rotatably supporting the monitor to the other side.

Furthermore, the DVD player with a monitor includes a cover being connected with the base, for covering one edge, serving as a central point of turning the monitor.

Also, the cover has one end being in contact with the surface of the monitor, and the other end being elastically supported by a spring.

In addition, the DVD player with a monitor includes a magnetic fixing device for fixing the monitor.

At this time, the magnetic fixing device includes a magnet provided at any one side of the monitor and the base; and a metal member provided at the other side of the monitor and the base.

At this time, the magnetic fixing device further includes a coil being wound on the metal member.

Also, a current flows through the coil to generate a repulsive force between the magnet and the metal member, when the monitor is opened.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 is a plane view of illustrating a DVD player with a monitor according to the first embodiment of the present invention;

FIG. 2A is a perspective view of illustrating a DVD player with a monitor of FIG. 1 when the monitor is in an open state;

FIG. 2B is a lateral view of illustrating a DVD player with a monitor of FIG. 1 when the monitor is in an open state;

FIG. 3 is a cross sectional view of illustrating a connection part between a base and a monitor;

FIGS. 4A and 4B are perspective views of respectively illustrating a first rotating connection part and a second rotating connection part;

FIG. 5 is a schematic view of illustrating a rotating device for rotating a monitor of a DVD player according to the present invention;

FIG. 6 is an expanded view of illustrating “A” portion of FIG. 5;

FIG. 7 is a disassembled perspective view of illustrating a connection structure between a rotating axis and a first rotating connection part provided in a DVD player with a monitor according to the present invention;

FIG. 8 is a schematic view of illustrating a braking device provided in a DVD player with a monitor according to the present invention;

FIGS. 9A and 9B are perspective views of respectively illustrating a brake washer and a friction washer provided in a braking device;

FIG. 10 is a cross sectional view of illustrating a DVD player with a monitor, which is installed on an inner surface of a top in a body of a vehicle, according to the second embodiment of the present invention;

FIG. 11 is a perspective view of illustrating a DVD player with a monitor according to the third embodiment of the present invention; and

FIGS. 12A and 12B are a plane view and a lateral view of illustrating “B” portion of FIG. 11.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

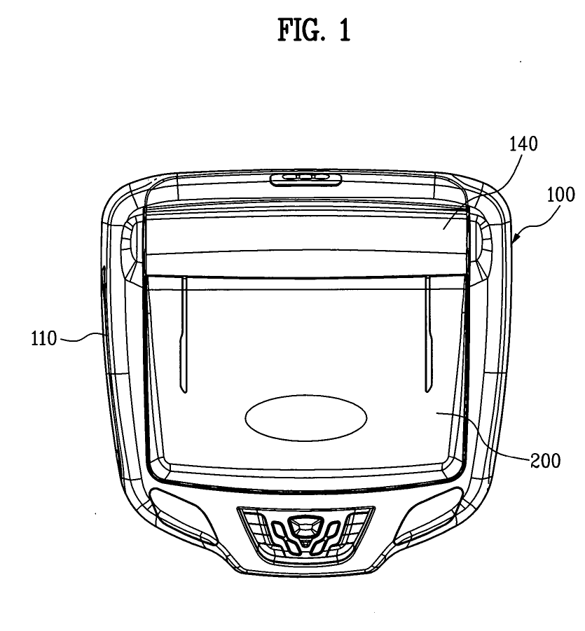

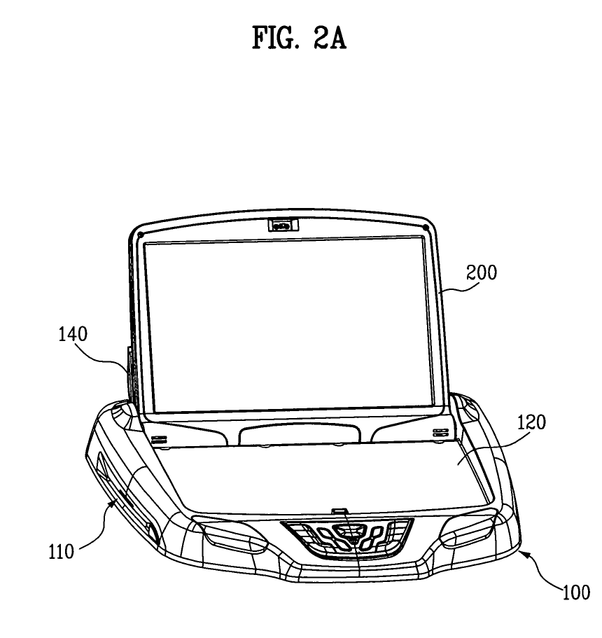

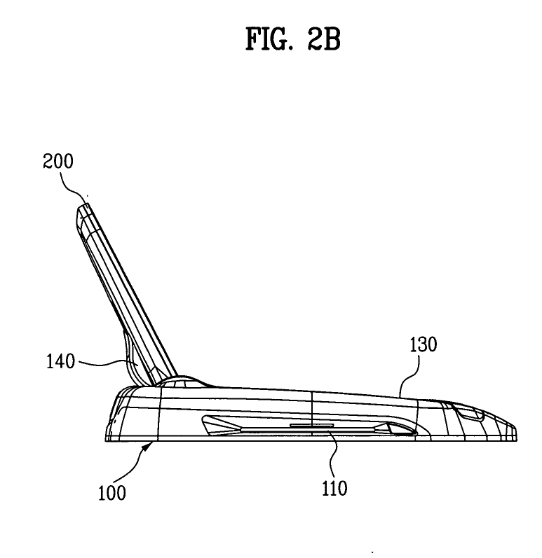

Hereinafter, a DVD player with a monitor according to the present invention will be described with reference to FIG. 1, FIG. 2A and FIG. 2B.

FIG. 1 is a plane view of illustrating a DVD player with a monitor according to the first embodiment of the present invention. FIG. 2A is a perspective view of illustrating a DVD player with a monitor of FIG. 1 when the monitor is in an open state. FIG. 2B is a lateral view of illustrating a DVD player with a monitor of FIG. 1 when the monitor is in an open state.

The DVD player with a monitor according to the first embodiment of the present invention is provided with a base 100 and the monitor 200, wherein the monitor 200 is rotatably connected with the base 100, for displaying images thereon.

At this time, a DVD inserting part 110 is provided at a side portion of the base 100, and various electrical components (not shown) are provided inside the base 100. At this time, the DVD inserting part 110 receives a DVD therein, and the various electrical components reproduce images recorded in the DVD.

Also, a monitor receiving part 120 is provided in the upper portion of the base 100, for receiving the monitor 200 therein. The monitor receiving part 120 is formed in correspondence with a shape of the monitor 200. Also, as going from a rear portion being rotatably connected with the monitor 200 to a front portion, the base 100 becomes thinner.

For this, the upper portion 130 of the base 100, for the monitor receiving part 120, is slantingly provided at a predetermined angle.

Preferably, the DVD inserting part 110 is different from other portions in color, so that the DVD inserting part 110 can be recognizable even in the dark surroundings.

Next, the monitor 200 is rotatably connected with the base 100. In this state, the monitor 200 turns on its one corner, and more particularly, on its rear corner, for being open and closed.

For this, a first rotating connection part 210 is provided at one rear side of the monitor 200, and a second rotating connection part 220 is provided at the other rear side of the monitor 200. At this time, the first rotating connection part 210 is connected with a rotating device provided in the base 100.

In the meantime, a cover 140 is provided at the rear corner of the base 100, for covering the rear corner of the base 100.

At this time, the cover 140 has a curvature, wherein a fore end of the cover 140 is closely adhered to a rear upper side of the monitor 200, and a rear end of the cover 140 is elastically supported by a torsion spring (not shown) provided to the rear corner of the base 100.

For rotating the monitor 200, there is requirement for providing a predetermined interval between a rear inner wall of the monitor receiving part 120 and the rear corner of the monitor 200. Thus, the cover 140 prevents foreign matters or a user's finger from being caught in the interval between the rear inner wall of the monitor receiving part 120 and the rear corner of the monitor 200 by covering the interval.

Also, it is preferable to provide a predetermined fixing device (not shown) in the front of the base 100, for fixation of the monitor 200 when the monitor 200 is in the closed state.

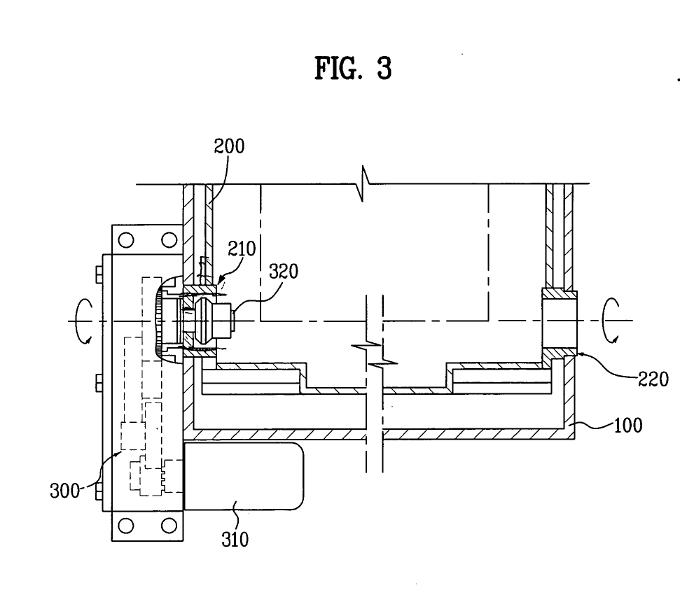

The rotating device of the DVD player with a monitor according to the present invention will be described with reference to FIG. 3 to FIG. 8.

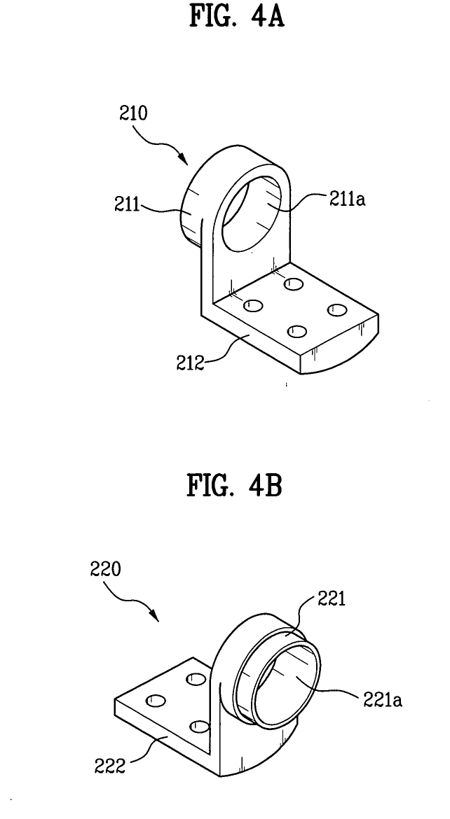

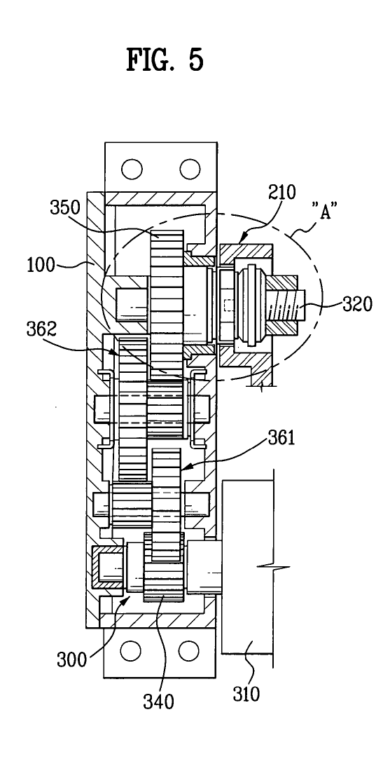

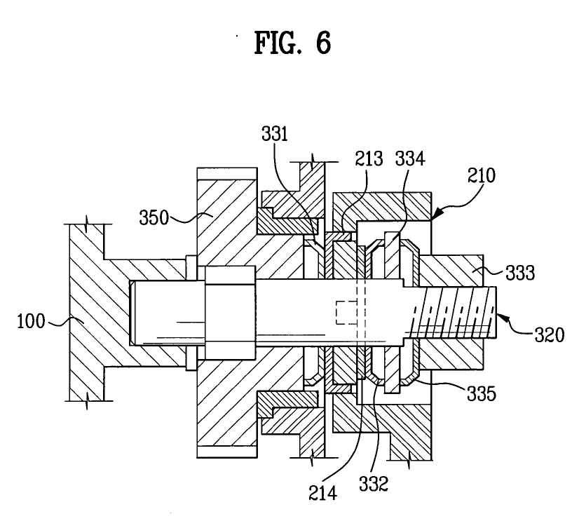

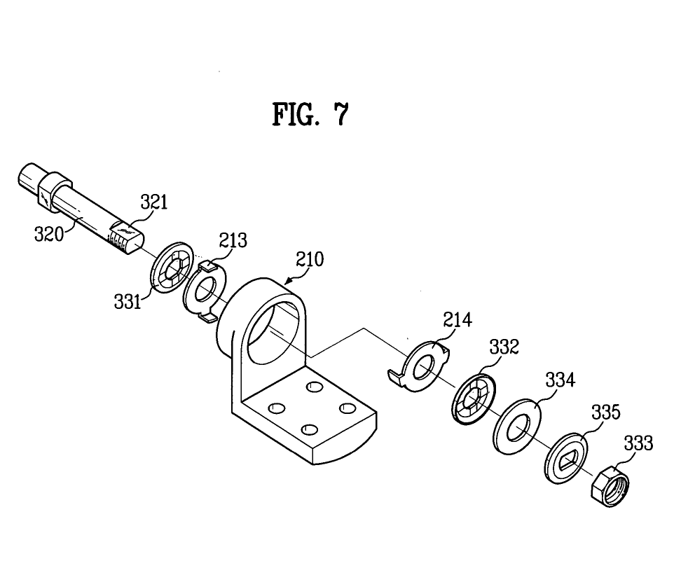

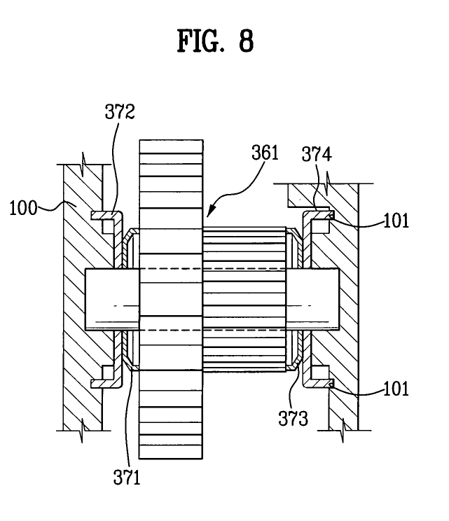

FIG. 3 is a cross sectional view of illustrating a connection part between a base and a monitor. FIGS. 4A and 4B are perspective views of respectively illustrating a first rotating connection part and a second rotating connection part. FIG. 5 is a schematic view of illustrating a rotating device for rotating a monitor of a DVD player according to the present invention. FIG. 6 is an expanded view of illustrating “A” portion of FIG. 5. FIG. 7 is a disassembled perspective view of illustrating a connection structure between a rotating axis and a first rotating connection part provided in a DVD player with a monitor according to the present invention. FIG. 8 is a schematic view of illustrating a braking device provided in a DVD player with a monitor according to the present invention.

In the DVD player with a monitor according to the present invention, the rotating device 300 transmits a rotary power of a motor 310 provided in the base 100 to the monitor 200, so that the monitor 200 turns.

Also, if a predetermined external force is applied to the monitor 200, the monitor 200 turns at a direction of the predetermined external force by the rotating device 300.

In more detail, the rotating device 300 will be described with reference to FIG. 3 to FIG. 8.

The rotating device 300 is provided with a shaft 320, slip members, and a power transmission device. At this time, the shaft 320 is connected with the first rotating connection part 210 of the motor 200, and the slip members are closely adhered to one end and the other end of the first rotating connection part 210. Also, the power transmission device transmits the rotary power of the motor 310 to the shaft 320, wherein the motor 310 is provided at one rear side of the base 100.

Herein, the first rotating connection part 210 is provided with a cylindrical first shaft cover 211 and a first connection part 212. At this time, the first connection part 212 is formed as one body with the first shaft cover 211, for being connected with one rear side of the monitor 200 by screw.

Also, a hole 211a is formed in the first shaft cover 211. In this state, an inside diameter of the hole 211a is larger than a diameter of the shaft 320. As a result, the shaft 320 passes through the hole 211a without any interference.

In the meantime, the second rotating connection part 220 is provided with a cylindrical second shaft cover 221 and a second connection part 222. At this time, the second connection part 222 is formed as one body with the second shaft cover 221, for being connected with the other rear side of the monitor 200 by screw.

Also, another hole 221a is formed in the second shaft cover 221 along a shaft direction. In this state, wires for connecting electrical components of the base 100 with electrical components of the monitor 200 pass through the hole 221a.

Then, the slip members transmit the rotary power of the shaft 320 to the first rotating connection part 210. Also, if a predetermined external force is applied to the monitor 200, the surface being adhered to the first rotating connection part 210 slips by the slip members.

In more detail, the slip members are comprised of a first slip washer 331 and a second slip washer 332. At this time, the first slip washer 331 is tightly adhered to an outer side of the first rotating connection part 210, and the second slip washer 332 is tightly adhered to an inner side of the first rotating connection part 210.

More preferably, the first rotating connection part 210 is comprised of a first friction washer 213 and a second friction washer 214.

At this time, the first friction washer 213 is connected with an outer side of the first rotating connection part 210, and is tightly adhered to the first slip washer 331 for obtaining a predetermined frictional force thereto.

Also, the second friction washer 214 is connected with an inner side of the first rotating connection part 210, and is tightly adhered to the second slip washer 322 for obtaining a predetermined frictional force.

For tightly coupling the friction washers 213 and 214 with the slip washers 331 and 332, the power transmission device is connected with one side of the shaft 320 for supporting one side of the first slip washer 331, and a nut 333 is connected with the other side of the shaft 320 by penetrating the hole 211a of the first rotating connection part.

According as the nut 333 is connected with the shaft 320, the second slip washer 332 is tightly adhered to the second friction washer 214, and simultaneously, one side of the first slip washer 331 is supported by the power transmission device, and the other side of the first slip washer 331 is tightly adhered to the first friction washer 213.

In the meantime, the rotating device 300 may additionally include a first fixation washer 334 provided between the second slip washer 332 and the nut 333, and a second fixation washer 335 provided between the first fixation washer 334 and the nut 333.

In order to smoothly transmit the rotary power of the shaft 320 to the first rotating connection part 210, a tapered surface 321 is formed in the other side of the shaft 320 connected with the nut 333. Also, a hole is provided in the second fixation washer 335, wherein a shape of the hole corresponds to the tapered surface 321 of the shaft 320.

Also, it is preferable to provide grease to a slip surface between the first slip washer 331 and the first friction washer 213, and to a slip surface between the second slip washer 332 and the second friction washer 214.

In the aforementioned structure, if a predetermined external force is applied to the monitor 200, the slip washers 331 and 332 slip from the friction washers 213 and 214. As a result, the monitor 200 turns by the external force, so that an impact of the external force is not transmitted to the motor 310 or the power transmission device.

Also, the monitor 200 may be open or closed by hand.

Next, the power transmission device is provided with a gear train and a braking device. At this time, the gear train includes a driving gear 340 turned by the motor 310, and a following gear connected with the shaft. Also, the braking device applies a brake power to the gear train.

The driving gear 340 is directly connected with the shaft of the motor 310. Also, at least one idle gear is provided between the driving gear 340 and the following gear, for transmitting the rotary power of the driving gear 340 to the following gear.

In the DVD player with a monitor according to the first embodiment of the present invention, a first idle gear 361 is provided between the driving gear 340 and the following gear, and a second idle gear 362 is provided between the first idle gear 361 and the following gear. At this time, the first idle gear 361 is in gear with the driving gear 340.

At this time, the first idle gear 361 and the second idle gear 362 are configured to sufficiently decrease a speed of the following gear 340 as compared with a speed of the driving gear 340 without the increase in size of the following gear 340. Accordingly, it is possible to decrease a thickness of the base 100 for receiving the power transmission device.

The braking device is provided to prevent the monitor 200 from being more turned at a predetermined angle by inertia of the gear train, so that the monitor 200 is stopped at a correct position.

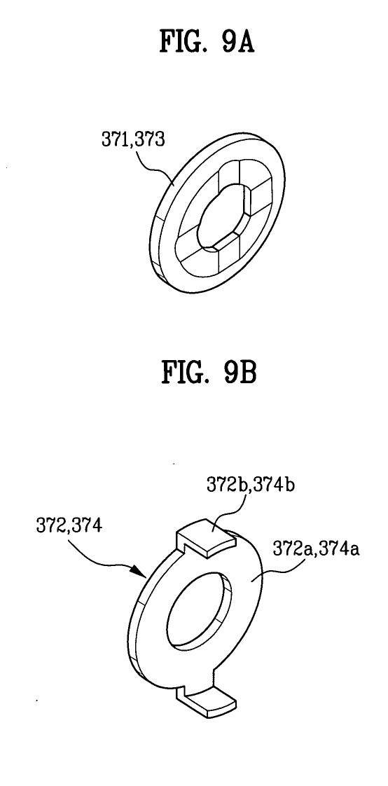

Referring to FIG. 8, and FIGS. 9A and 9B, the braking device includes a first brake washer 371, wherein the first brake washer 371 is provided at one side of the second idle gear 362, for being adhered to an inner wall of the base 100 of supporting the second idle gear 362, to obtain a predetermined frictional force.

In correspondence with this, a third friction washer 372 is provided in the inner wall of the base 100 of supporting the second idle gear 362, wherein the third friction washer 372 is fixed to the base 100 for being adhered to the first brake washer 371.

At this time, it is certain that a frictional force generated between the first brake washer 371 and the third friction washer 372 is below the rotary power of the motor 310.

As shown in FIG. 8, the braking device may additionally have a second brake washer 373 and a fourth friction washer 374. At this time, the second brake washer 373 is provided at the other side of the second idle gear 362. Also, the fourth friction washer 374 is adhered to the second brake washer 373 for having a predetermined frictional force.

Herein, the third friction washer 373 and the fourth friction washer 374 are respectively comprised of contact portions 372a and 374a being in contact with the first brake washer 371, and fixing portions 372b and 374b formed as one body with the contact portions 372a and 374a and inserted to a recess 101 formed in the inner wall of the base 100.

To prevent abrasion between the brake washers 371 and 373 and the friction washers 372 and 374, preferably, the brake washers 371 and 373 and the friction washers 372 and 374 are coated with a material suitable for improving abrasion resistance.

The braking device may be configured to apply the brake power to the first idle gear 361. However, in case the brake power is applied to the second idle gear 362, it is possible to stop the monitor 200 with rapidness and exactness.

In the aforementioned structure, on stopping the motor 310, the second idle gear 362 is stopped immediately, so that the monitor 200 is stopped at the correct position.

The DVD player with a monitor having the aforementioned structure is installed on an inner surface of a top in a body of a vehicle, so that the bottom of the base 100 is positioned upward. That is, if a user pushes a predetermined button (not shown) of a remote controller (not shown) or the base 100, the monitor 200 turns downward for being opened.

The DVD player with a monitor according to the first embodiment of the present invention may be formed in a small size for being installed on a desk or a table, or for being portable.

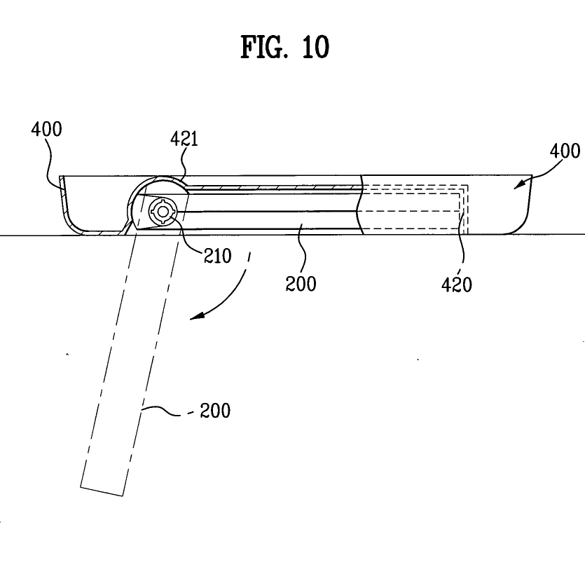

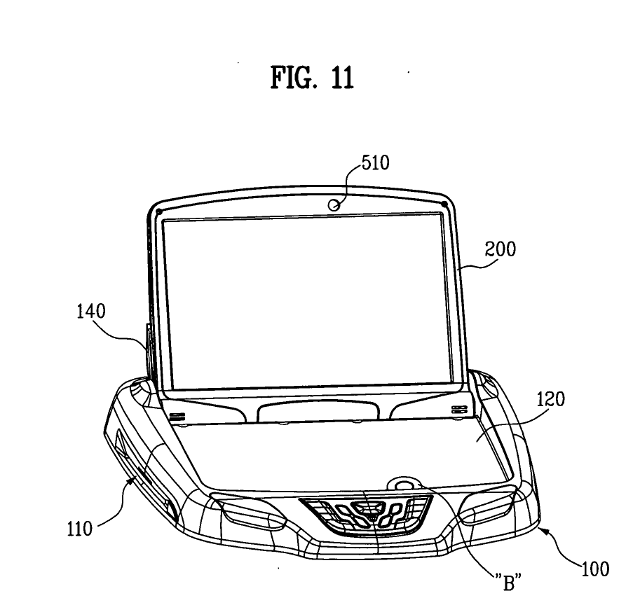

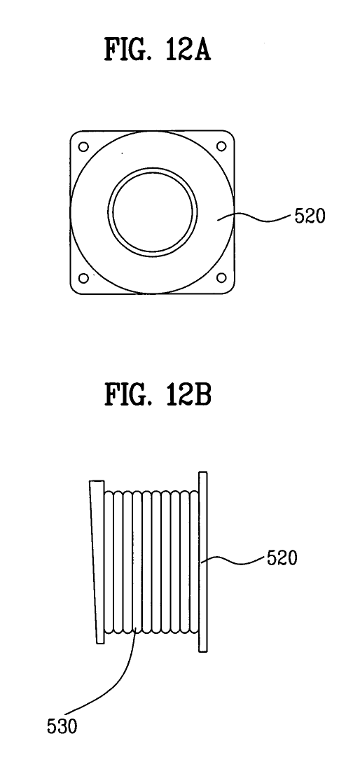

Next, a DVD player with a monitor according to the second embodiment of the present invention will be described with reference to FIG. 10, FIG. 11, and FIG. 12A and FIG. 12B.

FIG. 10 is a cross sectional view of illustrating a DVD player with a monitor, which is installed on an inner surface of a top in a body of a vehicle, according to the second embodiment of the present invention. FIG. 11 is a perspective view of illustrating a DVD player with a monitor according to the third embodiment of the present invention. FIGS. 12A and 12B are a plane view and a lateral view of illustrating “B” portion of FIG. 11.

On explaining the DVD player with a monitor according to the second embodiment of the present invention, the same reference numbers will be used throughout the drawings to refer to the same parts as those of the DVD player with a monitor according to the first embodiment of the present invention, and the repeated explanation for the same parts will be omitted.

First, as shown in FIG. 10, the DVD player with a monitor according to the second embodiment of the present invention is configured to minimize a distance between a lower end of a monitor 200 and an inner surface of a top in a body of a vehicle having the DVD player with a monitor, in state the monitor 200 is completely opened by being turned downward.

For this, the DVD player with a monitor according to the second embodiment of the present invention is comprised of a base 400 having a recess 421, wherein the recess 421 is formed along a read edge of a monitor receiving part 420 for receiving the monitor 200 therein.

At this time, when the monitor 200 turns, the recess 421 helps the monitor 200 for being turned without interference. That is, the monitor 200 turns on its rear edge without any interference, thereby minimizing a distance between the lower end of the monitor 200 and a central line of a shaft 210 of the monitor 200. Accordingly, it is possible to obtain a sufficient rear sight for a driver by minimizing a range obstructed by the monitor 200.

Next, a DVD player with a monitor according to the third embodiment of the present invention will be described with reference to FIG. 11, and FIGS. 12A and 12B. The DVD player with a monitor according to the third embodiment of the present invention includes a magnetic fixing device for fixing the monitor in state the monitor is in the closed state.

The magnetic fixing device is provided with a magnet 510 and a metal member 520. At this time, the magnet 510 is provided in the monitor 200, and the metal member 520 is provided in a base 100.

The magnet 510 is provided in the center of a fore end on an inner surface of the monitor 200 (corresponding to a lower end of the monitor 200 in state the monitor installed on an inner surface of a top in a body of a vehicle is in the open state). Also, the metal member 520 is provided in the center of a fore edge of a monitor receiving part 120.

In addition, the magnetic fixing device further includes a coil 530 wound around the metal member 520. That is, the metal member 520 wound with the coil 530 functions as an electromagnet.

Also, when the monitor 200 is in the open state, a current momentarily flows through the coil 530, to generate a repulsive force between the magnet 510 and the metal member 520. As a result, it is possible to prevent a load of the magnet 510 from being applied to a motor 310 of turning the monitor 200.

In the meantime, the DVD player with a monitor according to the preferred embodiments of the present invention is configured to watch a television or to reproduce a general CD.

As mentioned above, the DVD player with a monitor according to the present invention has the following advantages.

In the DVD player with a monitor according to the present invention, even if the external force is excessively applied to the monitor, the power transmitted to the motor or the power transmission device is minimized, so that it is possible to prevent the rotating device and the motor from being damaged.

Also, the DVD player with a monitor according to the present invention includes the cylindrical rotating connection part. Accordingly, it is possible to provide the wires through the rotating connection part with easiness. Thus, it is possible to prevent the electric shock or the disconnection of the wires since the wires are not exposed to the external.

In addition, the DVD player with a monitor according to the present invention includes the braking device, so that the monitor is stopped at the correct position.

Furthermore, in case of the DVD player with a monitor according to the present invention, it is possible to minimize the distance between the end of the monitor and the base when the monitor is in the open state, thereby minimizing a driver's sight obstruction in case the DVD player with a monitor according to the present invention is installed on the inner surface of the top in the body of the vehicle.

Also, the DVD player with a monitor according to the present invention includes the magnetic fixing device for preventing the monitor from shaking. Furthermore, in case the DVD player with a monitor according to the present invention is installed on the inner surface of the top in the body of the vehicle, the magnetic fixing device is more useful.

The magnet and the electromagnet of the magnetic fixing device provided in the DVD player with a monitor according to the present invention repel with each other by the repulsive force when the monitor is opened, thereby preventing the load of the magnet from being applied to the motor of turning the monitor.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A DVD player with a monitor comprising:
a base;
a monitor being rotatably connected with the base; and
a rotating device being connected with a motor of the base for turning the monitor, and having slip members of forming slip surfaces, for turning the monitor manually by a predetermined external force.

2. The DVD player with a monitor as claimed in claim 1, wherein the rotating device includes:
a shaft being inserted to a hole of a first rotating connection part provided in the monitor; and
the slip members being closely adhered to one side and the other side of the first rotating connection part, for transmitting a rotary power of the shaft to the first rotating connection part, and for generating the slip surface being adhered to the first rotating connection part when the predetermined external force is applied to the monitor.

3. The DVD player with a monitor as claimed in claim 2, wherein the slip members include:
a first slip washer being adhered to one side of the first rotating connection part; and
a second slip washer being adhered to the other side of the first rotating connection part.

4. The DVD player with a monitor as claimed in claim 3, wherein the first rotating connection part includes:
a first friction washer provided at one side of the first rotating connection part, and being adhered to the first slip washer; and
a second friction washer provided at the other side of the first rotating connection part, and being adhered to the second slip washer.

5. The DVD player with a monitor as claimed in claim 3, wherein the shaft has one side connected with a power transmission device for transmitting a rotary power of the motor, and the other side connected with a nut through the hole.

6. The DVD player with a monitor as claimed in claim 5, wherein the rotating device includes:
a first fixation washer provided between the second slip washer and the nut; and
a second fixation washer provided between the first fixation washer and the nut.

7. The DVD player with a monitor as claimed in claim 6, wherein the other side of the shaft is formed as a tapered surface.

8. The DVD player with a monitor as claimed in claim 7, wherein the second fixation washer has a hole corresponding to the tapered surface of the shaft.

9. The DVD player with a monitor as claimed in claim 5, wherein the power transmission device includes:
a gear train including a driving gear being rotated by the motor, and a following gear being connected with the shaft; and
a braking device for applying a brake power to the gear train.

10. The DVD player with a monitor as claimed in claim 9, wherein the gear train further includes an idle gear provided between the driving gear and the following gear.

11. The DVD player with a monitor as claimed in claim 10, wherein the braking device includes a spring washer provided at one side of the idle gear and being adhered to an inner wall of the base for obtaining a predetermined frictional force.

12. The DVD player with a monitor as claimed in claim 11, wherein the base includes a friction washer being adhered to the brake washer for obtaining a predetermined frictional force.

13. The DVD player with a monitor as claimed in claim 12, wherein the friction washer includes:
a contact portion being in contact with the brake washer; and
a fixing portion formed as one body with the contact portion, for being inserted to a recess formed in the inner wall of the base.

14. The DVD player with a monitor as claimed in claim 2, wherein lubricating grease is provided to surfaces between the respective slip members and the first rotating connection part.

15. The DVD player with a monitor as claimed in claim 1, wherein the monitor includes:
the first rotating connection part provided at one corner of the monitor, for being connected with the rotating device; and
a second rotating connection part provided at the other corner of the monitor, for being rotatably inserted to the base.

16. The DVD player with a monitor as claimed in claim 15, wherein the second rotating connection part includes:
a cylindrical second shaft cover being rotatably inserted to a support hole formed in thee base, and having a hole at a shaft direction; and
a second connection part formed as one body with the second shaft cover, and being connected with the other corner of the monitor.

17. The DVD player with a monitor as claimed in claim 16, wherein the second connection part is connected with the monitor by screw.

18. The DVD player with a monitor as claimed in claim 16, wherein the base includes a monitor receiving part for receiving the monitor in one surface thereof, and a recess formed along one edge of the monitor receiving part to help the edge of the monitor for being turned without any interference.

19. The DVD player with a monitor as claimed in claim 1, wherein the base becomes thinner as going from one side of rotatably supporting the monitor to the other side.

20. The DVD player with a monitor as claimed in claim 1, further comprising a cover being connected with the base, for covering one edge, serving as a central point of turning the monitor.

21. The DVD player with a monitor as claimed in claim 20, wherein the cover has one end being in contact with the surface of the monitor, and the other end being elastically supported by a spring.

22. The DVD player with a monitor as claimed 1, further comprising a magnetic fixing device for fixing the monitor.

23. The DVD player with a monitor as claimed in claim 22, wherein the magnetic fixing device includes:
a magnet provided at any one side of the monitor and the base; and
a metal member provided at the other side of the monitor and the base.

24. The DVD player with a monitor as claimed in claim 23, wherein the magnetic fixing device further includes a coil being wound on the metal member.

25. The DVD player with a monitor as claimed in claim 24, wherein a current flows through the coil to generate a repulsive force between the magnet and the metal member, when the monitor is opened.

26. The DVD player with a monitor as claimed in claim 1, wherein the monitor is opened by turning downward in state the base is fixed to an inner surface of a top in a body of a vehicle.
